(19) United States
(12) Patent Application Publication
(10) Pub. No.: US 2012/0137862 A1
(43) Pub. Date: Jun. 7, 2012

(54) ROBOTIC PAYLOAD DELIVERY DEVICE

(75) Inventors: Alex J. Kossett, Minneapolis, MN (US); Matthew Michael Sellner, St. Louis Park, MN (US); Andrew W. Drenner, Bloomington, MN (US)

(73) Assignee: RECONROBOTICS, INC., Edina, MN (US)

(21) Appl. No.: 13/308,417

(22) Filed: Nov. 30, 2011

Related U.S. Application Data
(60) Provisional application No. 61/418,257, filed on Nov. 30, 2010.
(60) Provisional application No. 61/418,261, filed on Nov. 30, 2010.

(51) Int. Cl. B05B 9/00; G05D 1/00

(52) U.S. Cl. 89/1.13; 701/2

(57) ABSTRACT

A portable robotic vehicle having modular components that can be interchanged to customize the vehicle for a particular mission or terrain so as to deliver a payload to a desired target. The payload attachment section can be interchanged with different payloads including shaped charges for safely detonating or disabling improvised explosive devices. The payload may be elevated or directed in a specific direction for positioning the shaped charge or otherwise directing an emission from the payload.

### PRIORITY CLAIM

This application claims priority to U.S. Provisional Application No. 61/418,257 filed Nov. 30, 2010, and entitled “EQUIPMENT FOR ROBOTIZING A PAYLOAD”, and U.S. Provisional Application No. 61/418,261 filed Nov. 30, 2010, and entitled “EQUIPMENT FOR ROBOTIZING A PAYLOAD”, which are hereby incorporated by reference in their entirety.

### FIELD OF THE INVENTION

The present invention related to surveillance robots. More particularly, the present invention relates to accessories and drive configurations for surveillance robots.

### BACKGROUND OF THE INVENTION

Recently, the use of remotely operated drones in combat, police actions and other dangerous situations has increased. In particular, unmanned ground vehicles can be used to remotely deliver a payload such as a surveillance packages or munitions to targets without risk of injury or death to the operator. The ground vehicles are often have lightweight and compact designs such that the vehicle can be carried into the combat theater. Similarly, the vehicles are often sized to be thrown a short distance by the operator before being driven to the final destination on its own power.

Although the compact size of the drones provides significant advantages, the small size of the vehicle can make navigating the vehicle over or around obstacles more challenging.

Similarly, different terrains can present unique challenges requiring specific vehicles or modifications for specific terrains. However, as the vehicles are typically carried to operational theatre, carrying multiple vehicles suited for different terrains or equipment for modifying the vehicle in theatre can be impractical.

Often times payloads need to be delivered in an operational theatre at a particular place of usage, for example explosives to disable or destroy an improvised explosive device (“IED”). It is obviously advantageous to deliver such payloads by means other than personnel walking up to and placing such explosives at the IED and thus robotic delivery options are desirable. Shaped water charges are known to accomplish such disabling and destruction of IEDs. Such charges are available in a standardized size of approximately 13 inches long×3 inches wide×2.5 inches high and upon detonation shoot a narrow, high velocity, low volume shaped water jet out the top and a lower velocity, higher volume, spread out water blast downward. See Prior Art FIG. 29. Such charge has a water jet emission direction f and will have two water reservoirs, one for the high velocity water jet and one for the lower velocity water blast. Obviously, the orientation can be changed, but such an orientation as described has been successfully used for the disabling and destroying of IEDs on the battle field. Strategic positioning both elevation wise and proximity horizontally are desirable for optimal effectiveness. Particularly IEDs buried in the ground or within trunks of vehicles, the lower velocity water blast triggering the ground based IED's typically by a pressure plate, and the higher velocity jet cutting through and disabling an IED in a trunk of a vehicle.

As such, there is a need for a means of delivering to an operational theatre an easily transportable robotic ground vehicle capable of addressing different terrains and obstacles.

### SUMMARY OF THE INVENTION

The present invention is directed to a portable robotic vehicle having modular components that can be interchanged to customize the vehicle for a particular mission or terrain. The robotic vehicle can generally comprise one or more payload attachment sections and at least two removable side drive assemblies positioned on either side of the payload attachment section. The payload attachment section can be readily attached and interchanged with different payloads including, but not limited to sensor packages, battery packages, weapons, and explosives. In an embodiment, the payload can comprise shaped charges for safely detonating or disabling improvised explosive devices (IEDs), particularly as described in the Background. Similarly, the side assemblies can comprise different types of drive systems for transporting and elevating the payload. The drive systems can be selected based on the particular payload to be transported, the type of terrain to be covered and the means by which the payload is to be delivered.

According to an embodiment, a robotic vehicle can generally comprise a payload attachment section and two side assemblies, wherein each side assembly can further comprise a single wheel assembly. Each wheel assembly can comprise a motor, an axle and a removable wheel. The wheel assemblies can be independently operated to drive and turn the robotic vehicle. The two wheel design allows the robotic vehicle to be compactly stowed for transport. According to an embodiment, each side assembly can further comprise a foldable tail assembly having a deployable tail foldable between a retracted position in which the deployable tail is positioned against payload attachment section and a deployed position in which the tail extends outwardly to stabilize the robotic vehicle. According to an embodiment, the payload attachment section can be attached to each side assembly across an elevating joint. The joint can be actuated to elevate the payload attachment section relative to the side assembly. In this configuration, the foldable tail assemblies can be used to stabilize the robotic vehicle to maintain the vehicle in an upright position as the payload attachment section is elevated.

According to an embodiment, a robotic vehicle can generally comprise a payload attachment section and two removable side assemblies, wherein each side assembly can further comprise two wheel assemblies mounted on rotatable arms. As with the two wheel configuration, each wheel assembly can comprise a motor, an axle and a removable wheel. Each wheel assemblies can also be operated individually or in various combinations to propel or rotate the robotic vehicle. The rotatable arms can be rotated independently or in various combinations to change the orientation and elevation of the payload attachment section.

According to an embodiment, each wheel can comprise a multi-spoke configuration having a hook portion extending from each spoke past the rim. The hook portion is adapted to engage obstacles, such as stair steps, to pull the robotic vehicle up and over obstacles as well as generally improving the traction of each wheel. The hook portion can comprise multiple hooks oriented to engage obstacles regardless of the direction the wheel are rotated.

According to an embodiment, each motor can be oriented parallel to the axle. Alternatively, each wheel assembly can further comprise a right-angle gear box for positioning the motor perpendicular to the axle while still rotating the axle. In this orientation, the motors of the robotic vehicle can be oriented to improve the ground clearance of the robotic vehicle.

A method of safely detonating an IED, according to an embodiment, comprises providing a robotic vehicle having a payload attachment section containing a shape charge, a first and second wheels, a first and second motor, and a first and second means of elevating each wheel. The method further comprises propelling the vehicle in first direction by rotating the first wheel with the first motor and the second wheel with the second motor, wherein the first and second motors can operated independently. The method further comprising navigating the robotic vehicle proximate to the IED. The method also comprises elevating the payload attachment section to position the shape charge proximite to the IED at a desired location. Finally, the method comprises detonating the shape charge to destroy or disable the IED. In embodiments of the invention, the shaped charge is also utilized to destroy all or portions of the robotic vehicle, particularly portions associated with the electronics and control circuitry so that there is no salvageable components that may be utilized by others.

In particular embodiments, the shaped charge need not be placed to actively destroy critical portions of the robotic vehicle and may be placed to preserver components or portions of the robotic vehicle.

In embodiments of the invention, a pair of drive mechanisms are attached to each end of a shaped charge, the drive mechanisms having conforming shape to attach to the shaped charge. The shaped charge having a standardized size of 10 to 16 inches in length.

In embodiments of the invention a pair of drive mechanisms including a motor, gears and a wheel, are separated a distance to receive a standardized size of a shaped charge, namely about 12.75 inches. A spanning member configured as a chassis may extend between the drive mechanisms whereby the chassis and the two drive mechanisms define a shaped charge receiving region. The drive mechanisms may include height adjustment mechanisms.

In an embodiment, each of a pair of drive mechanisms are positioned at the end of a shaped charge, the shaped charge having water jet and water blast capability on detonation. Each drive mechanism may have height adjustment capability to raise and lower the shaped charge. At least one of the drive mechanisms may have an extending portion therefrom for providing rotational stability about an axis extending through two wheels of the two drive mechanisms. The extending portion may be a tail to drag on the ground or a wheel that engages the ground.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawings, in which:

FIG. 1 is a perspective view of a robotic vehicle according to an embodiment of the present invention.

FIG. 2 is a partially exploded perspective vehicle of the robotic vehicle depicted in FIG. 1.

FIG. 3 is a cross-sectional side view of a wheel-axle-motor assembly according to an embodiment of the present invention.

FIG. 4 is a cross-sectional side view of a gear box according to an embodiment of the present invention.

FIG. 5 is a perspective view of the robotic vehicle depicted in FIG. 1 having a payload attachment section positioned in the elevated position according to an embodiment of the present invention.

FIG. 6 is a side view of the robotic vehicle depicted in FIG. 1 wherein the payload attachment section is positioned in a lowered position according to an embodiment of the present invention.

FIG. 7 is a side view of the robotic vehicle depicted in FIG. 1 wherein the payload attachment section is positioned in an elevated position according to an embodiment of the present invention.

FIG. 8 is a front view of the robotic vehicle depicted in FIG. 1 wherein the payload attachment section is positioned in the lowered position according to an embodiment of the present invention.

FIG. 9 is a front view of the robotic vehicle depicted in FIG. 1 wherein the payload attachment section is positioned in the elevated position according to an embodiment of the present invention.

FIG. 10 is a bottom view of the robotic vehicle depicted in FIG. 1 with the wheels removed according to an embodiment of the present invention.

FIG. 11 is a side view of the robotic vehicle depicted in FIG. 1 having at least one deployable tails rotated into an extended position.

FIG. 12 is a side view of the robotic vehicle depicted in FIG. 11 in which the deployable tails are rotated and locked into place with a locking pin according to an embodiment of the present invention.

FIG. 13 is a top view of the robotic vehicle depicted in FIG. 1 in which the deployable tails are folded into the retracted position according to an embodiment of the present invention.

FIG. 14 is a perspective view of the robotic vehicle depicted in FIG. 13 according to an embodiment of the present invention.

FIG. 15 is a partial side view of the robotic vehicle depicted in FIG. 13 according to an embodiment of the present invention.

FIG. 16 is a perspective view of a robotic vehicle according to an embodiment of the present invention.

FIG. 17 is a side view of the robotic vehicle depicted in FIG. 16.

FIG. 18 is a front view of the robotic vehicle depicted in FIG. 16.

FIG. 19 is a bottom view of a side assembly according to an embodiment of the present invention.

FIG. 20 is a cross-sectional side view of an arm actuator assembly according to an embodiment of the present invention.

FIG. 21 is a perspective view of the robotic vehicle depicted in FIG. 16 wherein the arm actuator assembly has be operated to rotate the actuator arms to elevate the payload attachment section.

FIG. 22 is a side view of the robotic vehicle depicted in FIG. 21.

FIG. 23 is a partially exploded perspective view of the robotic vehicle depicted in FIG. 16.

FIG. 24 is a partial perspective view of rotatable shaft of the payload attachment section according to an embodiment of the present invention.

FIG. 25 is a bottom view of the payload attachment section according to an embodiment of the present invention.

FIG. 26 is a side view of the robotic vehicle depicted in FIG. 16 with the payload attachment section rotated relative to the side assemblies according to an embodiment of the present invention.

FIG. 27 is a side view of the arm actuator assembly according to an embodiment of the present invention.

FIG. 28 is a perspective view of the robotic vehicle depicted in FIG. 26.

FIG. 29 is a schematic view of a shaped charge that emits a water jet and a water blast.

FIG. 30-31 are simplified elevational views of a robotic vehicle delivering a shaped charge to an IED in the ground.

FIG. 32 is simplified elevational view of a robotic vehicle delivering a shaped charge to an IED in the trunk of a vehicle.

FIG. 33 is a view of a robotic vehicle according to an embodiment of the invention.

FIG. 34 is a view of a robotic vehicle according to an embodiment of the invention.

FIG. 35 is a view of a robotic vehicle according to an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

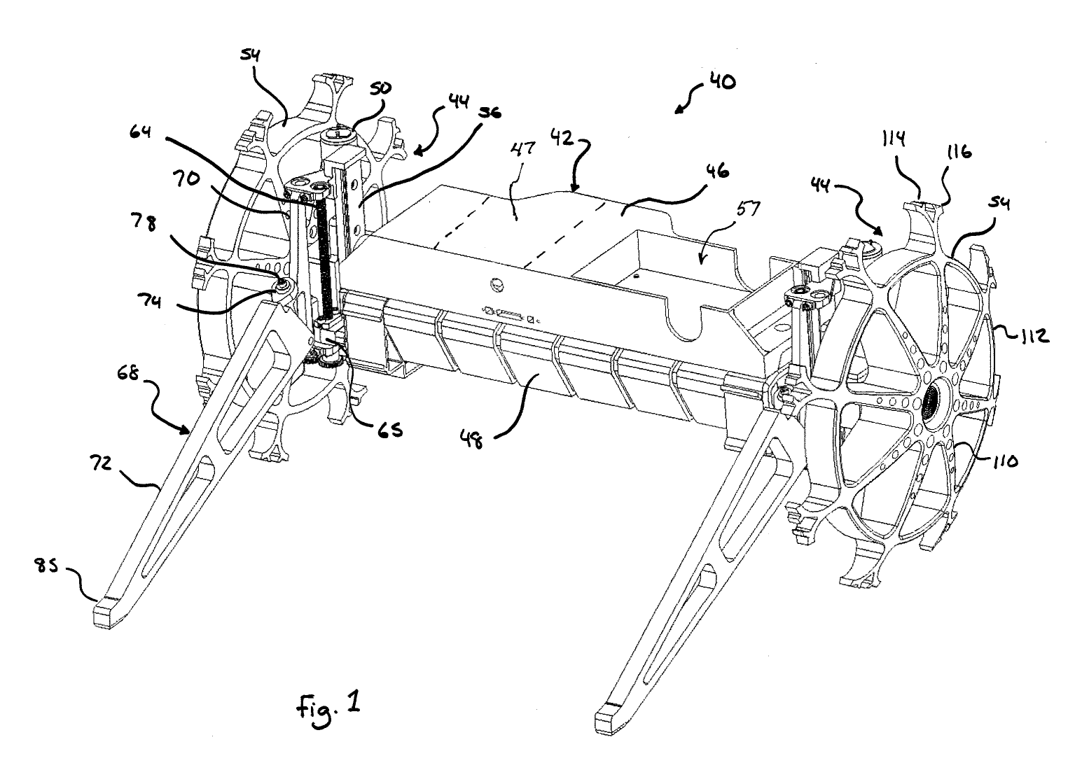

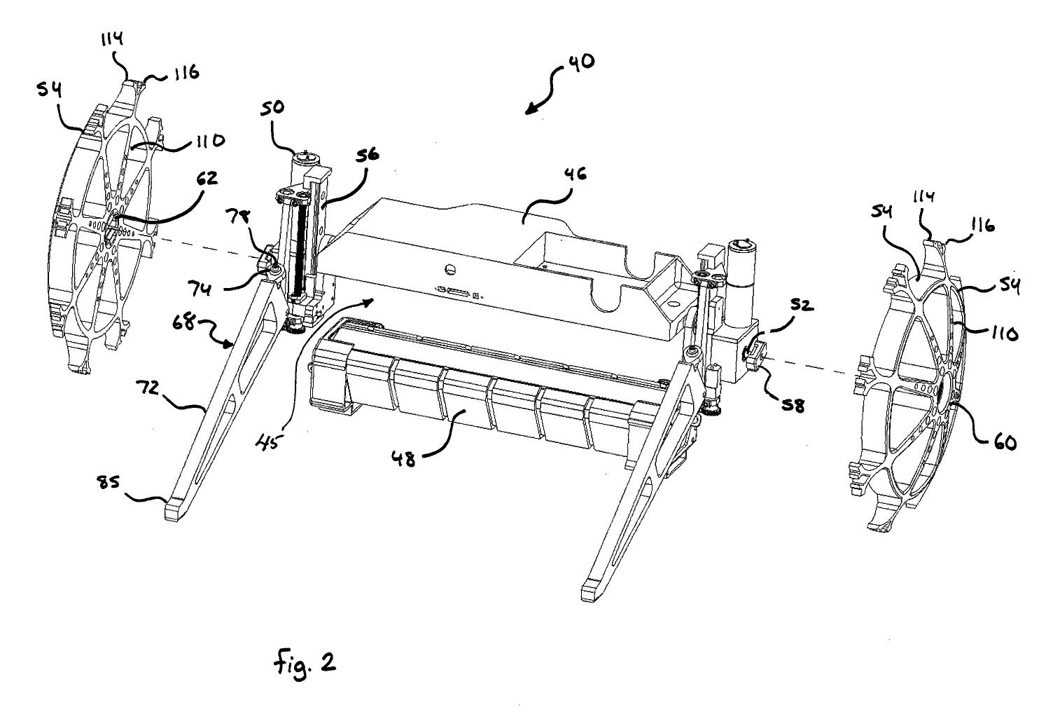

As shown in FIGS. 1 to 2, a robotic vehicle 40, according to an embodiment, can comprise a chassis or payload attachment section 42 and two side assemblies 44 with a payload receiving region 45 therebetween. The payload attachment section 42 can comprise electronics and control circuitry 46 that may define a designated critical portion 47 and other components for operating the robotic vehicle 40. According to an embodiment, the payload attachment section 42 can attach to a shaped charge 48 for disabling or destroying IEDs. The attachable may be by a variety of fastening means including bolts, screws, rivets, tab-and-slot, straps snaps, hook and loop material or other conventional mechanical connection means. The side assemblies 44 can each further comprise a motor 50, an axle 52, a removable wheel 54 and a mount assembly 56 for connecting each side assembly 44 to the payload attachment section 42. In an embodiment the side assemblies and chassis 42 are sized and spaced to accommodate a standardized sized charge of approximately 12 to 14 inches in length, 3 to 4 inches in depth, and 2 to 3 inches in height. An additional payload receiving region 57 may be defined in the chassis. Such payload contained therein may be a remote control detonation control unit 59 including components for detonating the shaped charge 48.

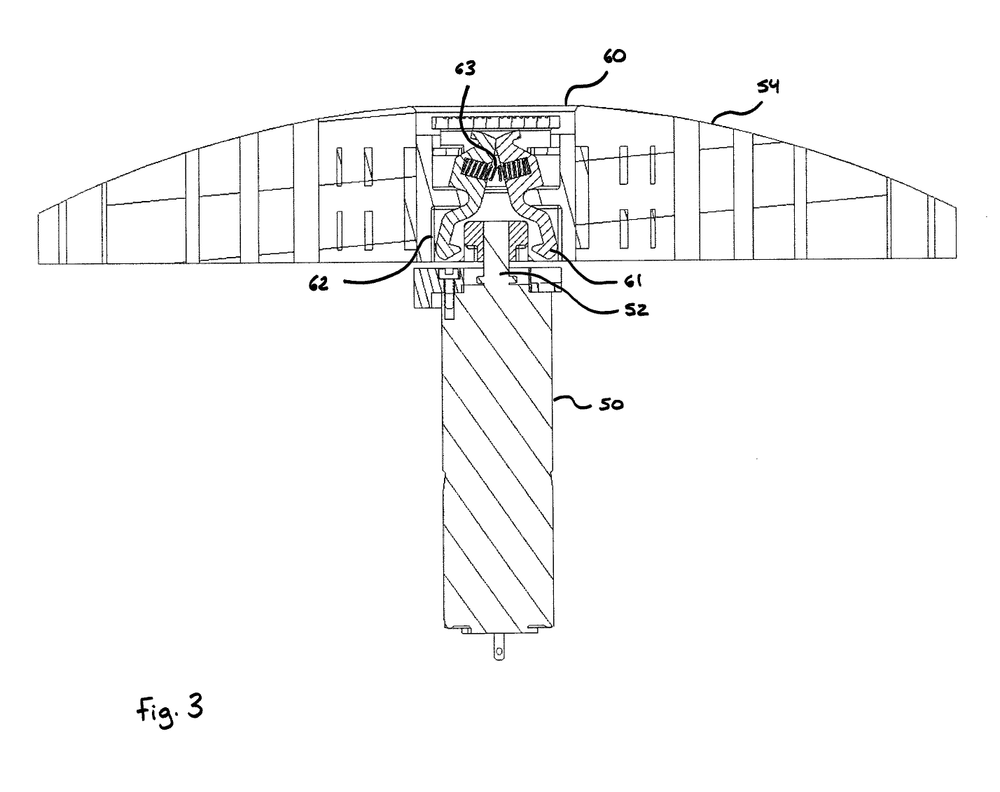

As shown in FIGS. 2 to 3, each axle 52 can further comprise a bolt head 58 at the end of the axle 52. As depicted in FIGS. 2 to 3, the bolt head 58 comprises a T-shape, but can comprise a hex-shape or other conventional bolt head shapes. In this configuration, the removable wheel 54 can further comprise a hub 60 defining a socket 62 corresponding to the bolt head 58. In operation, the bolt head 58 is inserted into the socket 62 to affix the wheel 54 to the axle 52. According to an embodiment, the hub 60 can further comprise at least two claws 61 that can be closed to grip the bolt head 58 to retain the bolt head 58 within the hub 60. A spring 63 to bias the claws 61 closed to engage the bolt head 58.

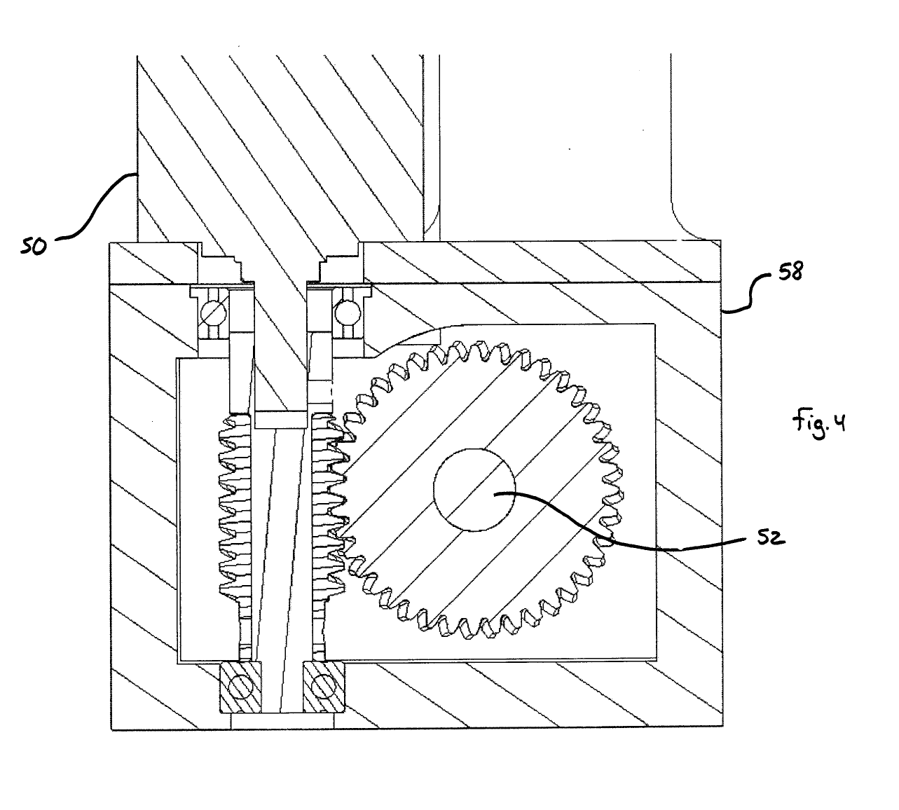

As shown in FIGS. 1 to 4, each motor 50 is operably engaged to the corresponding axle 52 to rotate the axle 52 and any attached wheel 54. As shown in FIGS. 2 and 4, according to an embodiment, each side assembly 44 can further comprise a gear box 58 permitting the motor 50 to be positioned at an angle transverse to the rotational axis of the corresponding axle 52. As shown in FIGS. 4, according to an embodiment, the motor 50 can be oriented at an angle perpendicular to the axle 52.

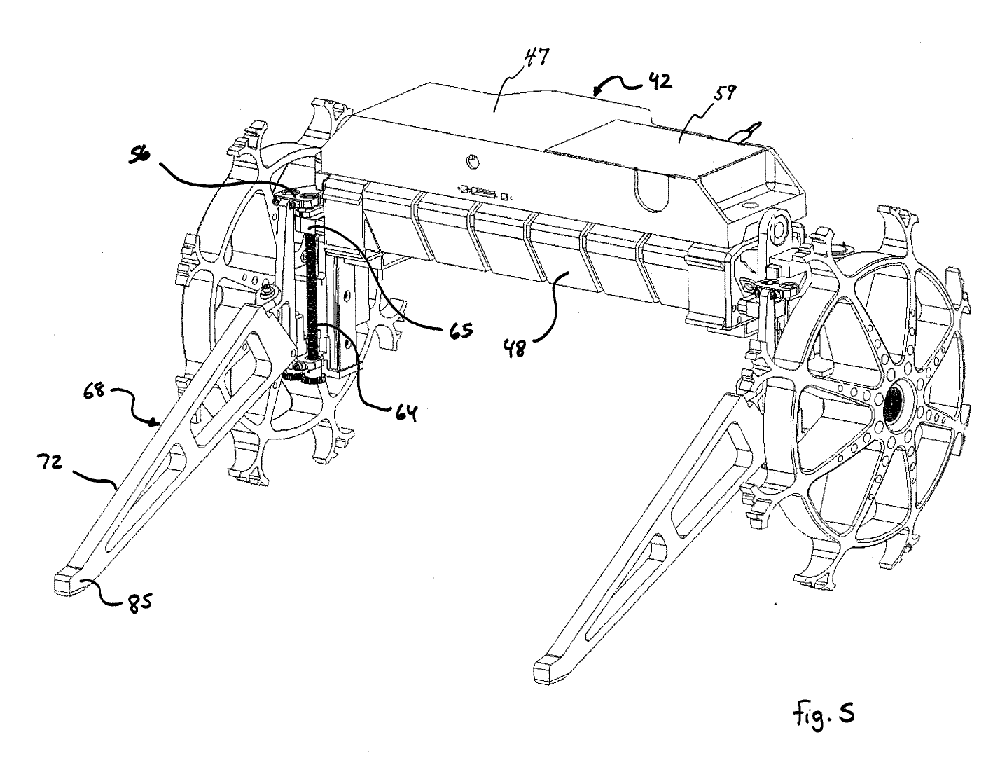

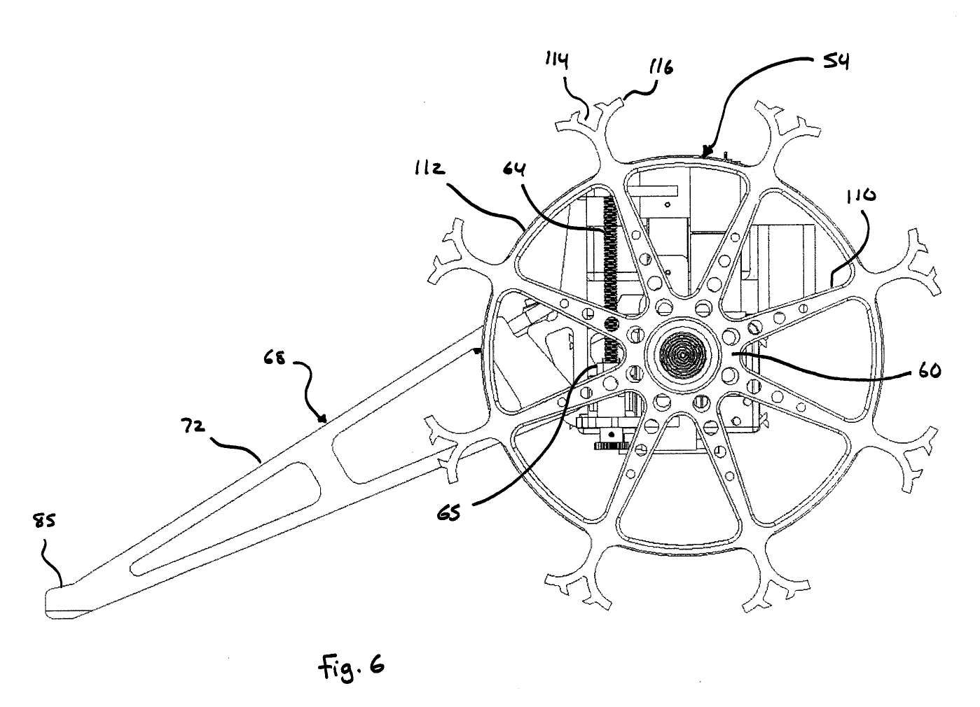

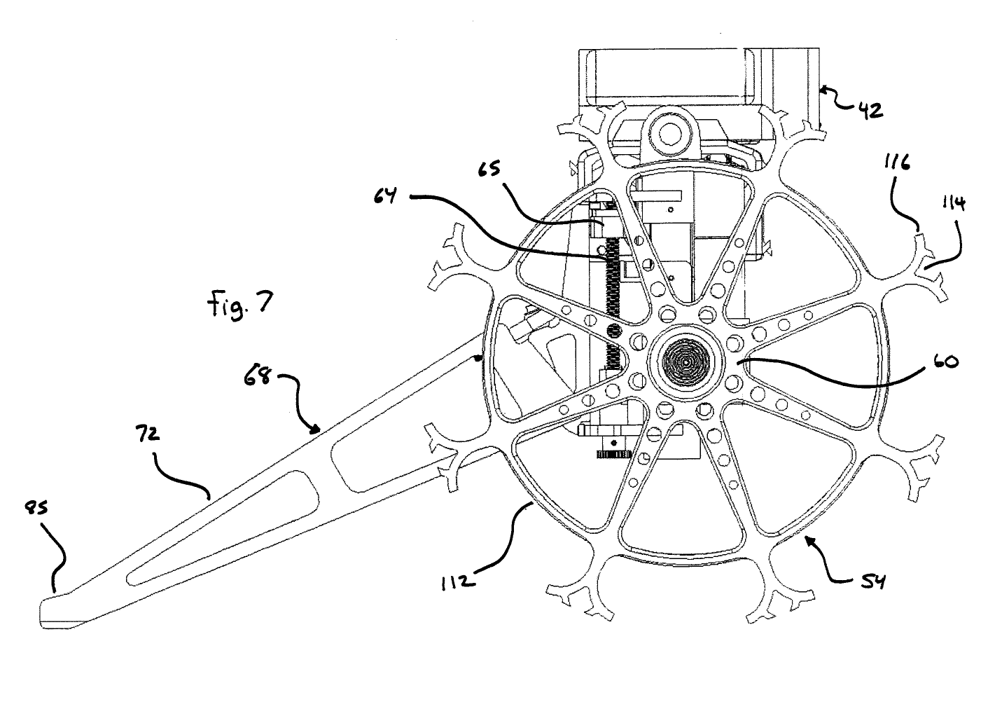

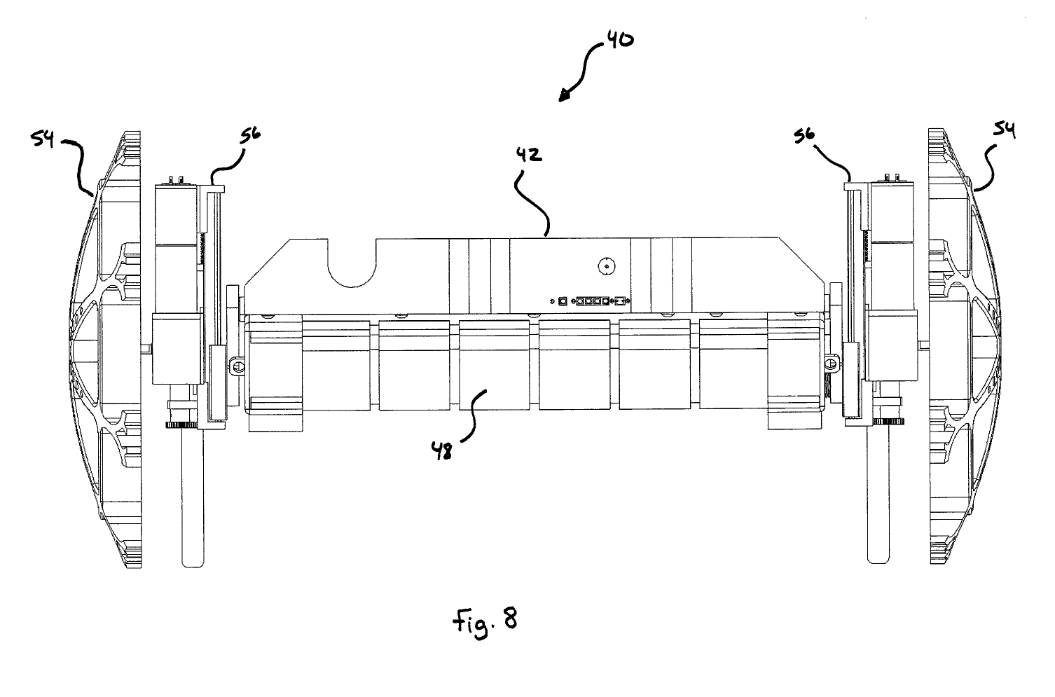

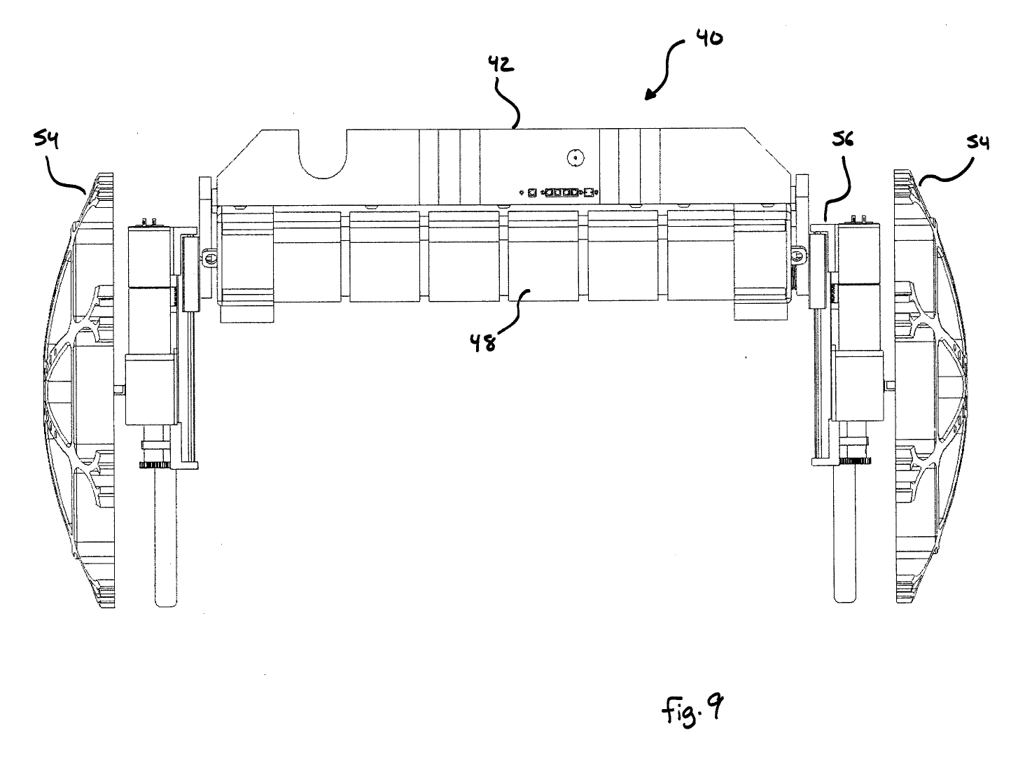

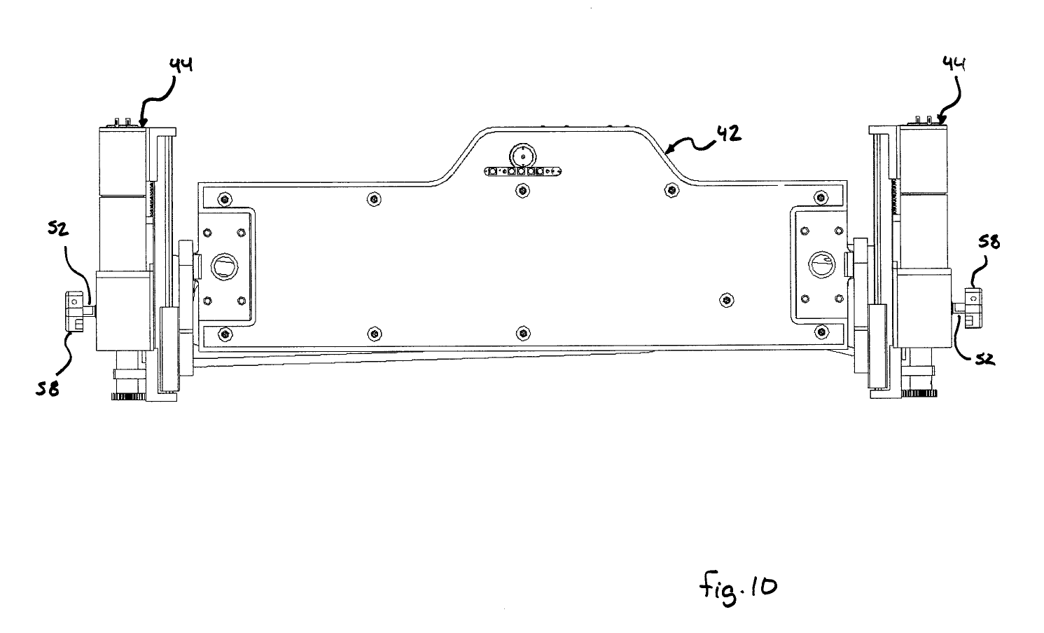

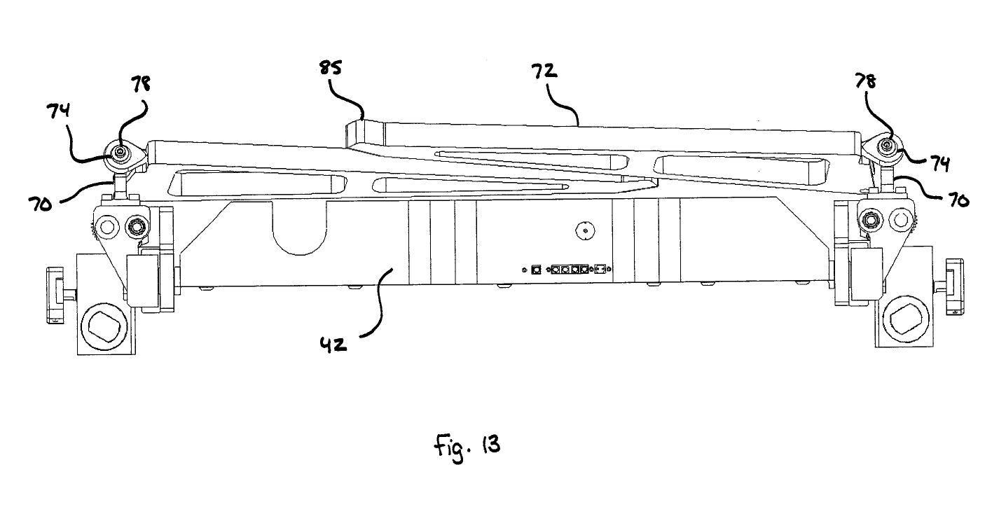

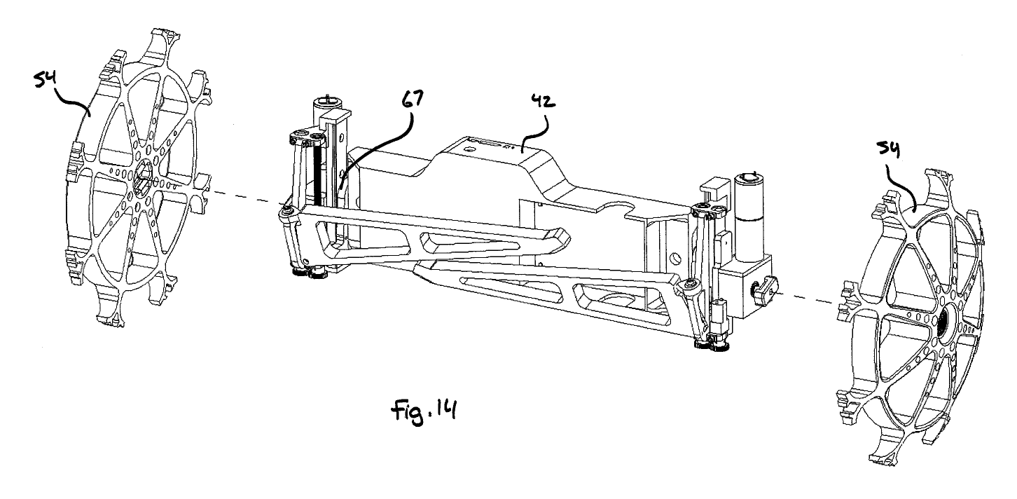

As shown in FIGS. 5 to 9, side assemblies 44, configured as drive mechanisms, can be mounted to the payload attachment section 42 via the mount assembly 56 such that the payload attachment section 42 is suspended above the ground when the wheels 54 are positioned on the corresponding axles 52. According to an embodiment, the wheels 54 can sized such that the payload attachment section 42 may be suspended at least six inches above the ground. Each mount assembly 56 further comprises a worm gear 64 and a payload bracket 65 having a threaded portion for engaging the worm gear 64. As shown in FIGS. 5 to 9, rotating of the worm gear 64 moves the payload bracket 65 along the length of the worm gear 64. The payload bracket 65 is mounted to payload attachment section 42 such that the rotation of the worm gear 64 elevates or lowers the payload attachment section 42. As shown in FIGS. 14 to 15, according to an embodiment, the mount assembly 56 can further comprise a rotatable joint 67 for rotating the payload attachment section 42 relative to the side assemblies 44 allowing for more efficient transport of the robotic vehicle 40.

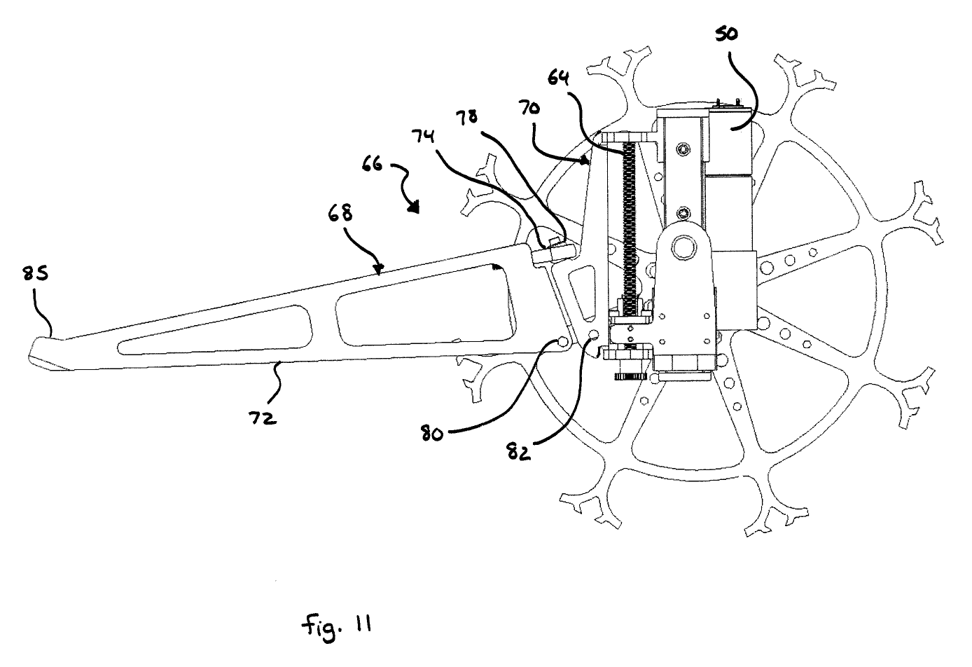

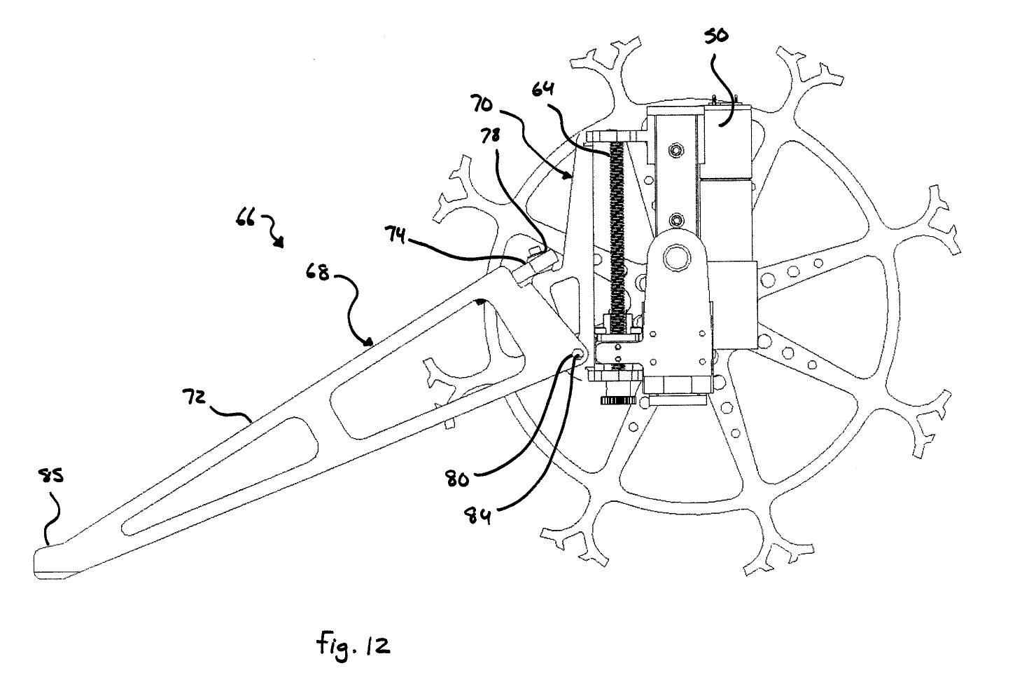

As shown in FIGS. 11 to 15, each side assemblies 44 can further comprise a foldable tail assembly 66 having a deployable tail 68 and a hinge bracket 70. Each deployable tail 68 further comprises an elongated portion 72 and a ball joint socket 74. The hinge bracket 70 further comprises a ball stud 78 insertable into the ball joint socket 74. In operation, the elongated portion 72 of the deployable tail 68 is rotatable around the ball stud 78 around a first axis between a retracted position shown in FIG. 13 in which the elongated portion 72 is positioned against the payload attachment section 42 and an extended portion shown in FIG. 11 in which the elongated portion 72 extends outwardly from the payload attachment section 42. According to an embodiment, the deployable tail 68 further define a first bore hole 80. Similarly, the hinge bracket 70 can also define a second bore hole 82 corresponding to the first bore hole 80. After the elongated portion 72 is rotated into the extended position, the elongated portion 72 can then be rotated around a second axis to align the first and second bore holes 80, 82. According an embodiment, the first and second bore holes 80, 82 are positioned such that the tip of the elongated portion 72 is positioned to engage the ground and maintain the payload attachment section 42 in the upright portion during movement of the robotic vehicle 40. A locking pin 84 can be inserted through the first and second bore holes 80, 82 to lock the elongated portion 72 in the extended position. As shown in FIGS. 11 to 12, the deployable tail 68 can further comprise an angled portion 85 for engaging the ground to stabilize the vehicle 40 when the deployable tail 68 is extended.

In operation, the robotic vehicle 40 can be transported to the operational theatre with the wheels 54 removed allowing the robotic vehicle 40 to be more tightly packet. Upon arriving, the bolt head 58 of each side assembly 44 can be inserted into the corresponding socket 62 of the wheel 54. According to an embodiment, the robotic vehicle 40 can be transported with the deployable tails 68 retracted against the payload attachment section 42 to minimize the space required for the robotic vehicle 40 during transport. After arriving at the theatre, the deployable tails 68 can be deployed to stabilize the robotic vehicle 40 during transport and elevating or lowering of the payload attachment section 42. The robotic vehicle 40 can then be driven to the desired location by the operator. The wheels 54 are sized such that the payload attachment section 42 is suspended above the ground regardless of the orientation of the robotic vehicle 40. Similarly, according to an embodiment, the robotic vehicle 40 can be transported to the place of deployment with the deployable tails 68 folded against the payload attachment section 42. Once maneuvered to the desired location, the worm drive 64 of each side assembly 44 can be actuated to elevate the payload attachment section 42 and thus the shaped charge 48 attached thereto.

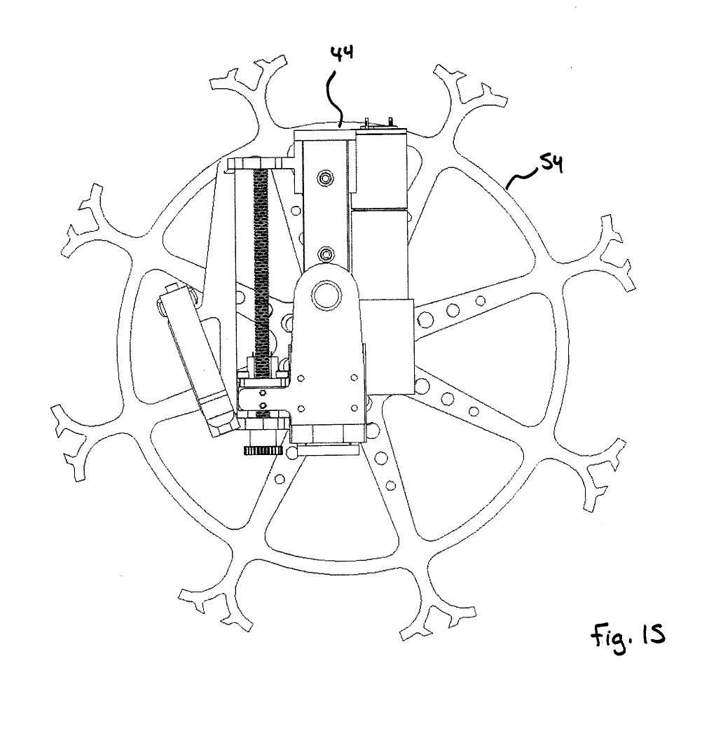

As shown in FIGS. 16 to 18, the robotic vehicle 40, according to an embodiment can alternatively comprise the payload attachment section 42 and two removable side assemblies 90. Each removable side assembly 90 can further comprise two actuating arms 92 and an arm actuator assembly 94. Each actuating arm 92 further comprises a wheel gear 108 at one end and a motor 50, an axle 52 and a removable wheel 54 positioned at the opposite end. Each arm actuator assembly 94 further comprises a toothed engagement element 96 and a worm gear 98.

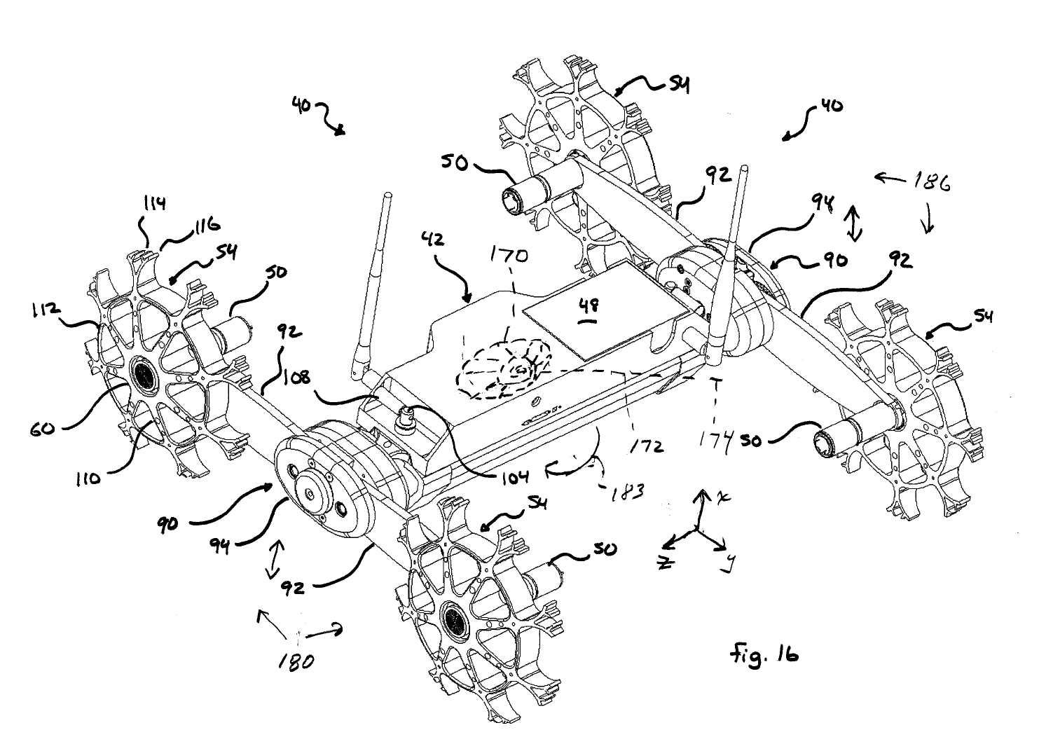

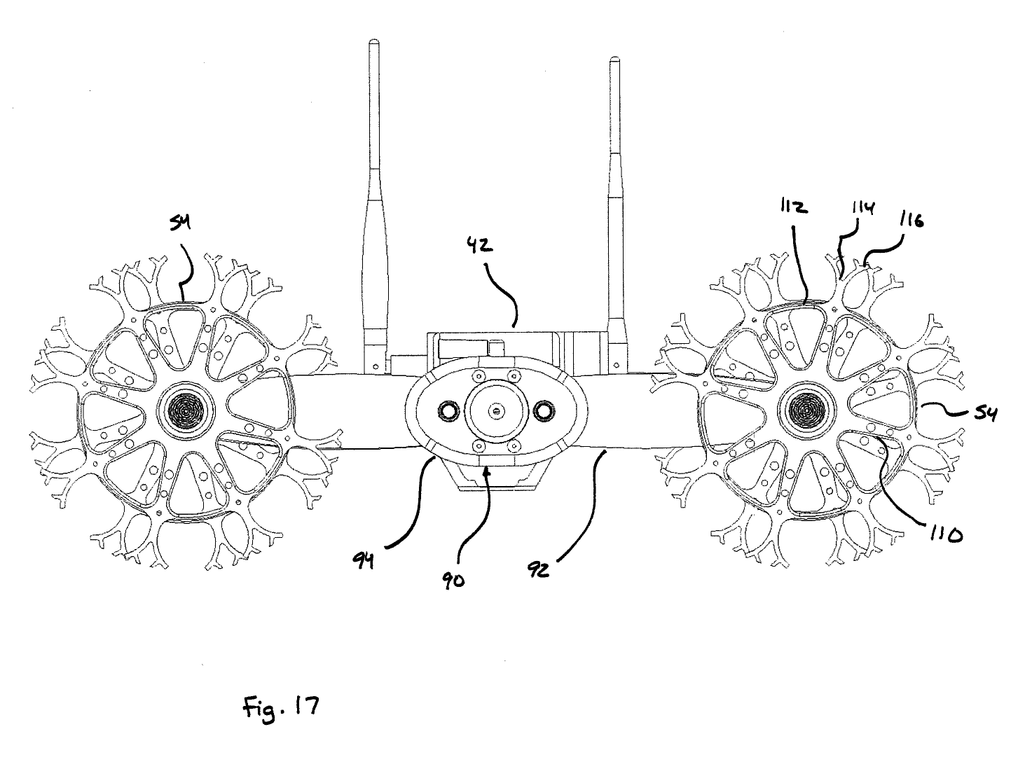

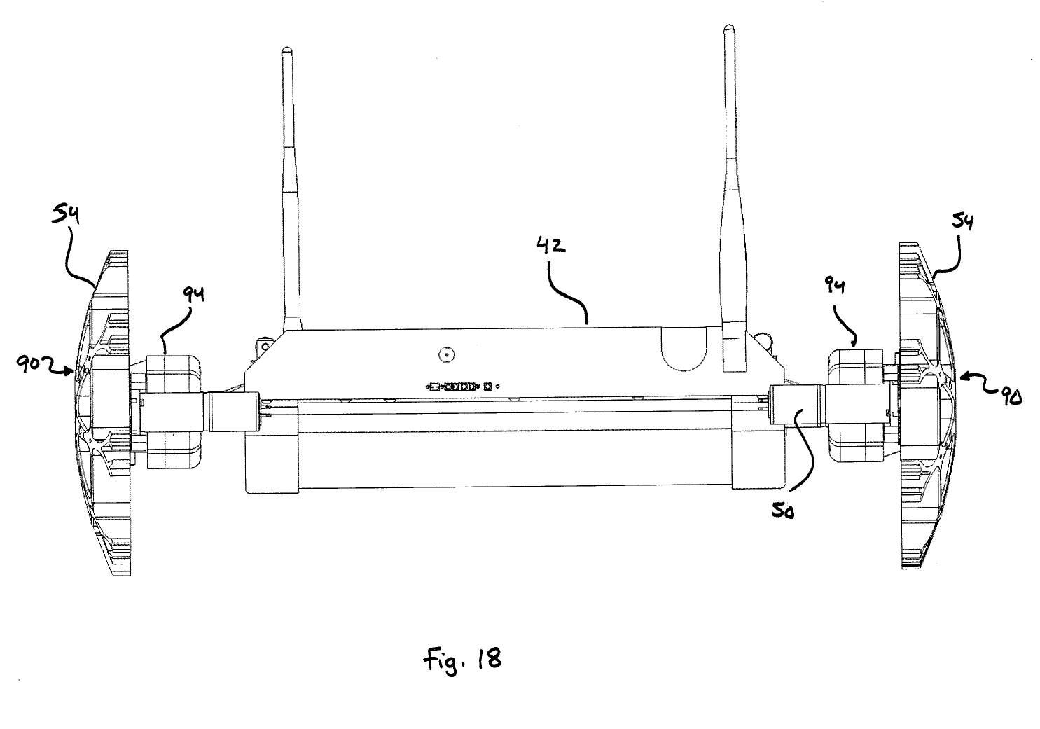

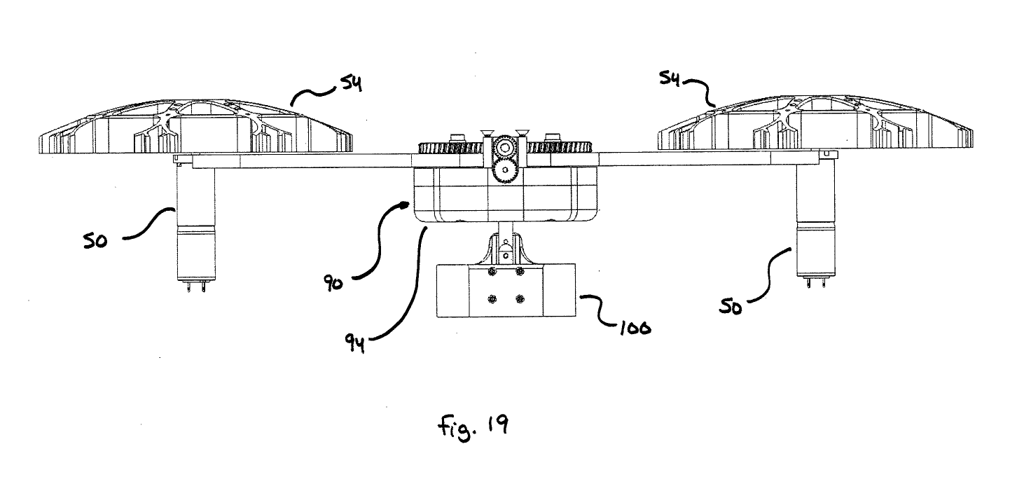

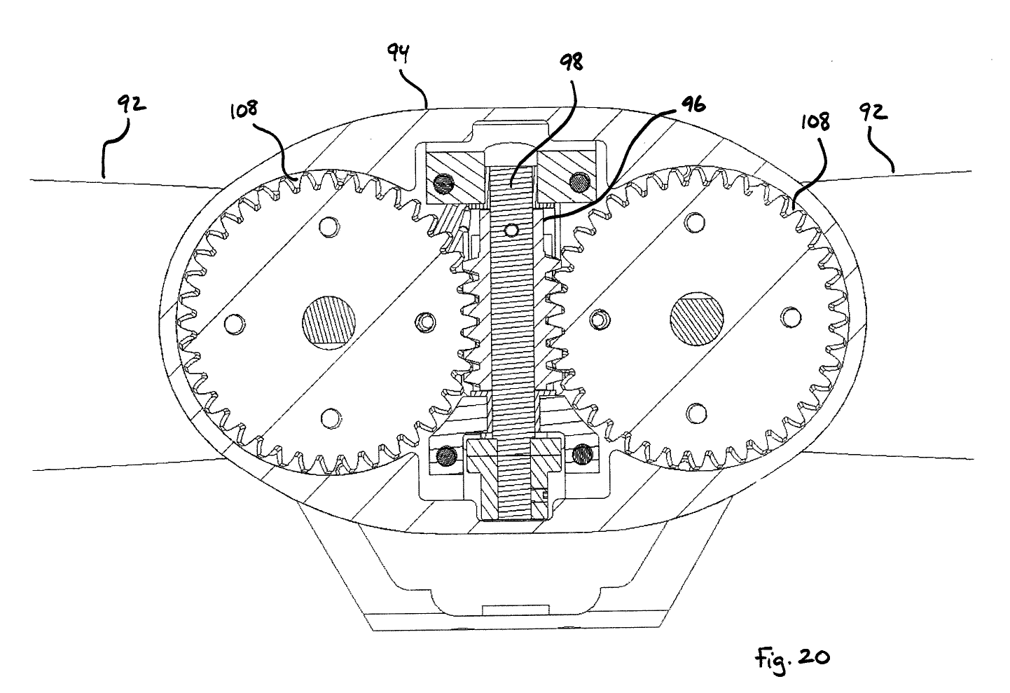

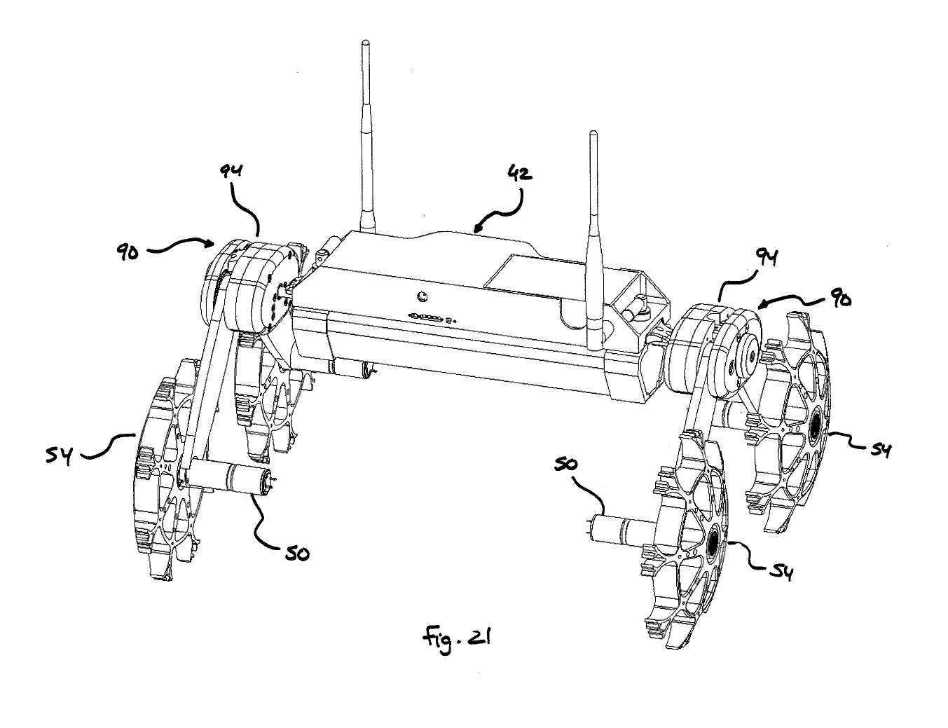

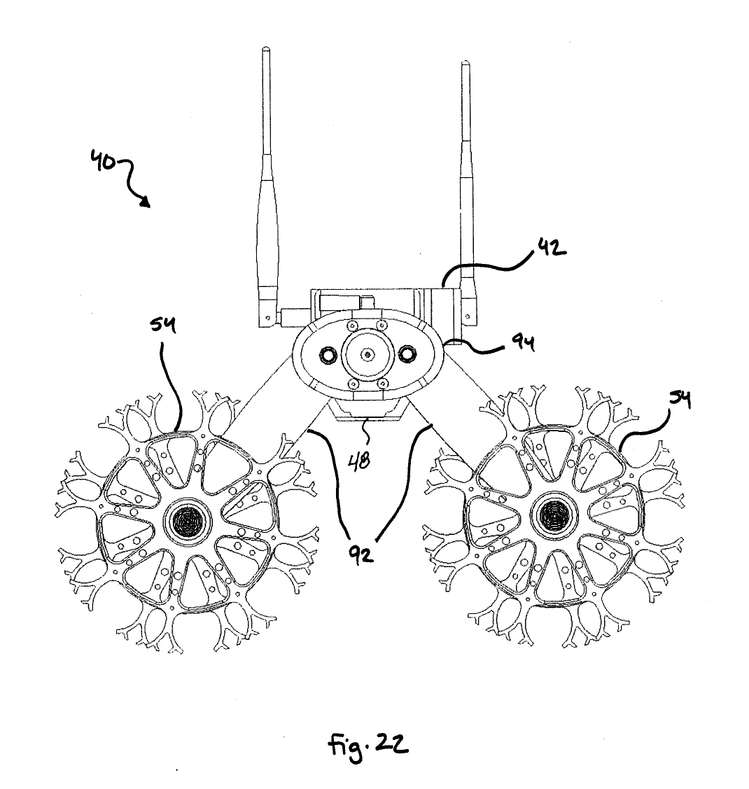

As shown in FIGS. 19 to 20, each axle 52 is positioned to extend through end of the corresponding actuating arm 92 such that the motor 50 and removable wheel 54 are positioned on opposite sides of the actuating arm 92 when the removable wheel 54 is mounted to the bolt head 58. At the opposite end, the wheel gear 108 of each actuating arm 92 is engaged to the toothed engagement feature 96 of the actuator assembly 94. The worm gear 98 of the actuator assembly 94 can be rotated to move the toothed engagement feature 96 axially, wherein the movement of the toothed engagement feature 96 rotates the wheel gear 98 to rotate the corresponding arm 92. As shown in FIGS. 21 to 22, each arm 92 can be rotated between a first angle in which the arm 92 is substantially horizontal in which the payload attachment section 42 is lowered proximate to the ground and a second angle in which the payload attachment section 42 is substantially elevated above the ground. According to an embodiment, the worm gears 98 of the two arms 92 of each single side assembly 90 are engagable to the same toothed engagement feature 96 such that the arms 92 rotate simultaneously.

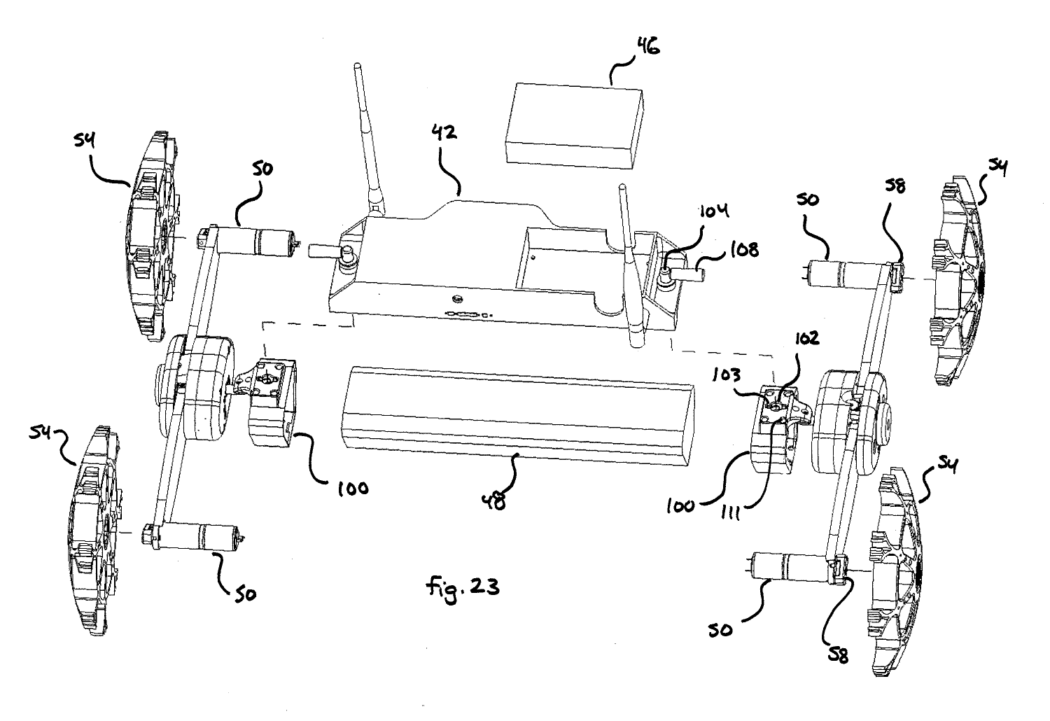

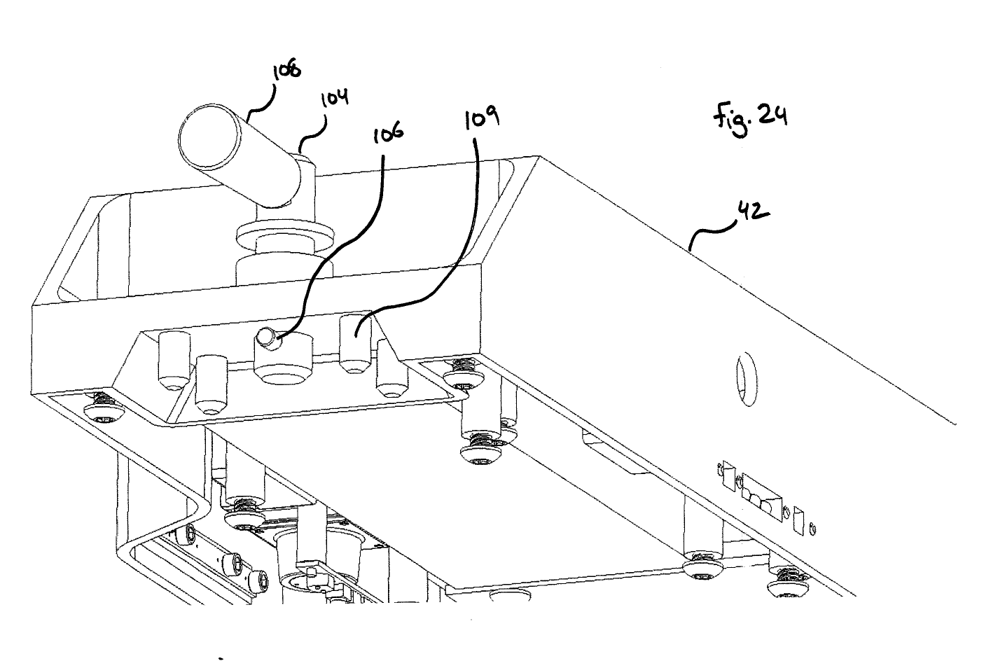

As shown in FIGS. 23 to 25, according to an embodiment, each side assembly 90 can further comprise a mount assembly 100 defining a locking aperture 102 having at least one slot 103. In this configuration, the payload attachment section 42 can comprise a corresponding rotatable shaft 104 defining an engagement tooth 106. The rotatable shaft 104 is inserted into the locking aperture 102 with the engagement tooth 106 aligned with the slot 103. The rotatable shaft 104 is then rotated until the tooth 106 is out of alignment with the slot 103 locking the payload attachment section 42 to the side assembly 90. According to an embodiment, the rotatable shaft 104 can further comprise a handle 108 for tool-less rotation of the rotatable stud 104. According to an embodiment, the payload attachment section 42 can further comprise at least one alignment shaft 109 corresponding to at least one alignment aperture 111 for preventing torquing of the side assembly 90 relative to the payload attachment section 42 after the side assembly 90 and payload attachment section 42 are connected.

As shown in FIG. 23, the robotic vehicle 40 can be provided with the removable side assemblies 90 and payload attachment section 42 separated. According to an embodiment, the wheels 54 can also be removed from the side assemblies 90. Each rotatable shaft 104 is then inserted into the corresponding locking aperture 102 and rotated to lock the side assembly 90 to the payload attachment section 42. Similarly, the bolt head 58 of each motor axle 52 can then be inserted into the corresponding socket 62 of each wheel 54 to attach the wheels 54 to the side assemblies 90. During operation of the vehicle 40, the motors 50 can be operated individually or in combination to propel the vehicle 40 to the desired location. The arm actuator assemblies 94 can be operated to rotate the actuating arms 92 so as to elevate or lower the payload attachment section 42.

As shown in FIGS. 1 and 16, each wheel 54 can further comprise a rim 110 and plurality of spokes 110 extend from the hub 60 to the rim 112. According to an embodiment, each wheel 54 can further comprise at least one cleat 114 each having at least two hook protrusions 116. The hook protrusions 116 are oriented such that at least one of the hook protrusions 116 can engage an obstacle regardless of the direction the wheel 54 is being rotated.

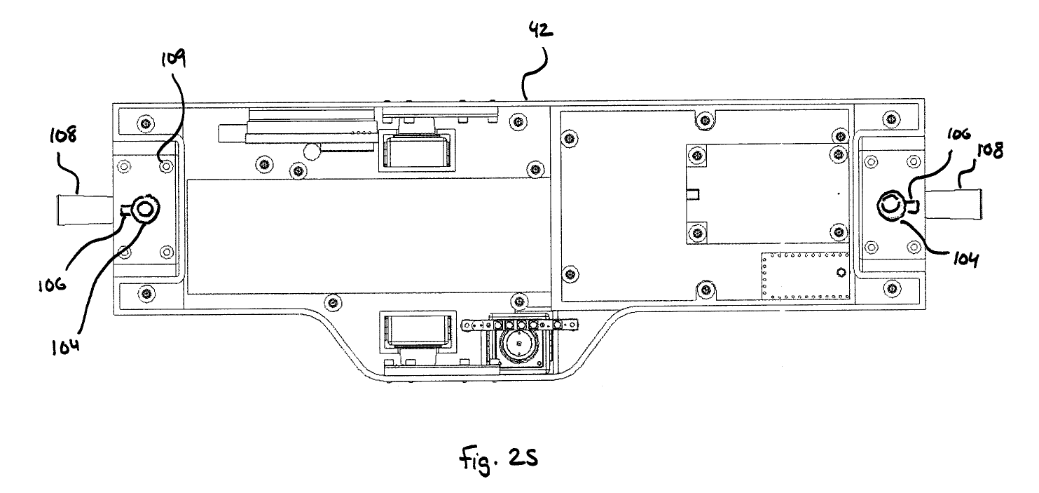

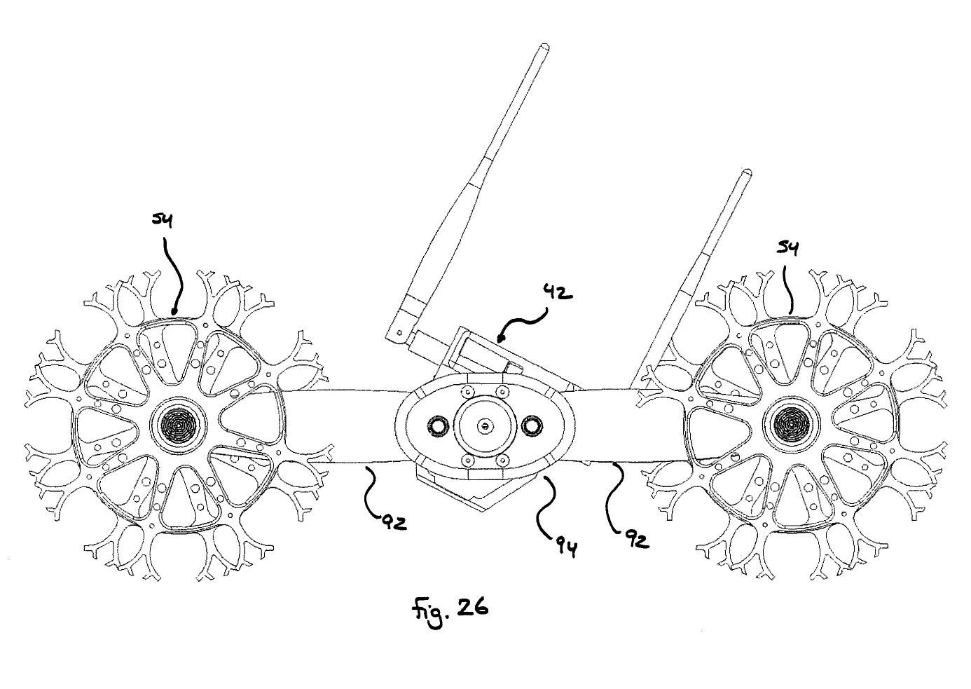

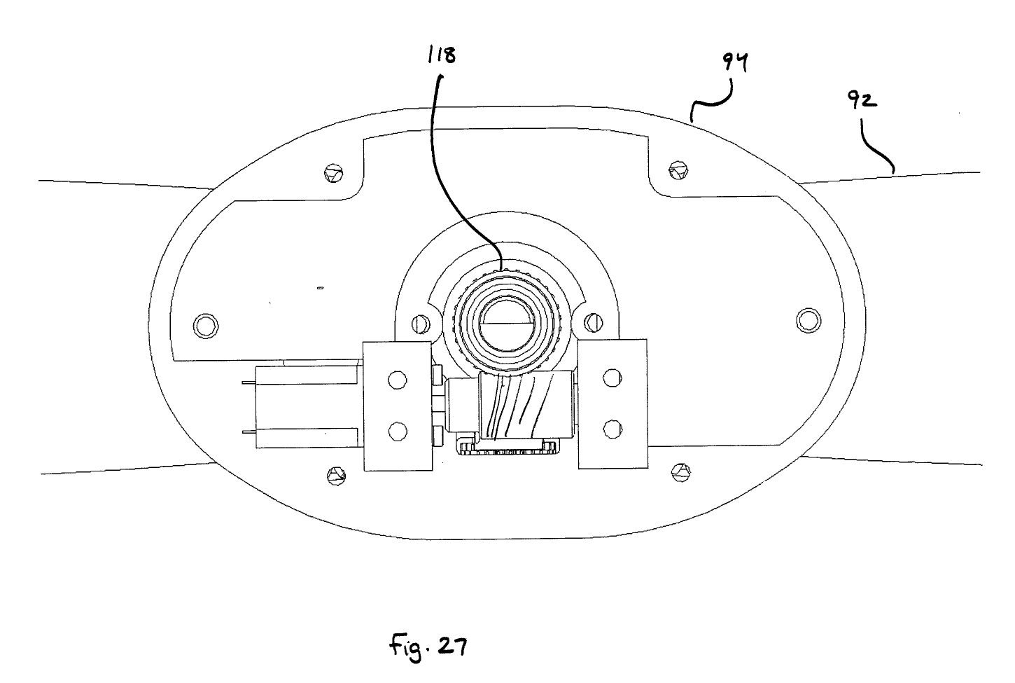

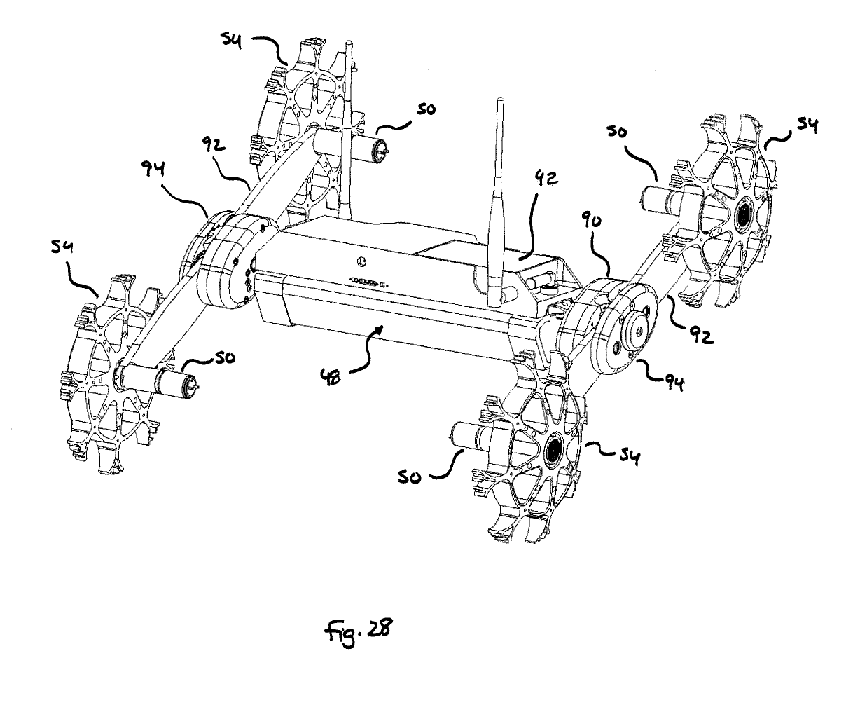

As shown in FIGS. 26 to 28, each mount bracket 100 can operably connected to corresponding arm actuator assembly 94 via a rotating joint 118. The rotating joint 118 can be operated to rotate the payload attachment section 42 relative to arm actuator assemblies 94 and arms 92.

According to an embodiment, the payload attachment section 42 can comprise a shaped charge 48 for destroying or disabling IED devices. The shape charge 48 can be fitted with a water container 122 for creating a water column or blade for disrupting the function of the IED device without detonating the IED device. The elevating mount assembly 56 or arm actuator assembly 94 can be used to elevate the payload attachment section 42 containing the shaped charge 120 proximate to the IED or a vehicle containing the IED before the shaped charge 48. Similarly, according to an embodiment, the rotating joints 118 can be used rotate the payload attachment section 42 to point the shaped charge 48 at the IED. After the payload attachment section 42 is properly positioned, the shaped charge 48 can be detonated to destroy or disable the IED device.

According to an embodiment, the payload attachment section 42 can contain the majority of the necessary electronics, including communications, power supply, and sensors. In addition, the side assemblies 44, 90 can contain peripheral electronics such as motor drivers, which may be connected to the central assembly by an electrical cable. The payload attachment section 42 can contain one or more cameras, which may face in various directions, including downward, which allows for fine positioning of the payload by, for instance, lining up a target object with a reticle or similar alignment marking on the operator's display unit. The operator can use the robot's motion controls to adjust the position until the target is lined up with the reticle. Some or all of the cameras may have a complementary light-bar which can illuminate the environment with a suitable spectrum of light, such as IR or visible.

According to an embodiment, the robot 40 can be controlled and monitored remotely with a complementary handheld unit operated by a user with minimal training. The handheld unit can include transmitters and receivers complementary to the robot's transmitters and receivers, an interface such as a video screen to monitor the robot, and a control interface such as a joystick or set of buttons. The handheld until can also include specialized transmitters configured for use with an explosives payload that can be attached to the robot. In one embodiment the explosives package can be configured to destroy both a target IED and the robot simultaneously or portions of the robot. U.S. Pat. No. 7,559,385 B1 is incorporated by reference herein and includes disclosure relating to remote control robots with cameras.

Referring to FIGS. 30 to 32, the operation of embodiments of the invention in an operational theatre are illustrated. In FIG. 30, a robotic vehicle with a shaped charge including water is remotely driven to a detonation 125 location adjacent an IED 126. The robotic vehicle elevates the shaped charge to a desired elevation e and the charge is detonated destroying designated critical portions of the robotic vehicle, such as the remote control circuitry in the chassis and the detonation package for the shaped charge, and providing a downward water blast that detonates the IED. The detonation of the IED may itself not be enough to destroy the particular portions of the robotic vehicle that are destroyed by the shaped charge.

Referring to FIG. 32, the robotic vehicle is transported in a pack 128 from the shaped charge pack 129 containing one or a plurality of such shaped charges to the location of usage 130. The robotic vehicle is assembled and a shaped charge 48 is placed in the receiving region 45 and in embodiments, the detonation control unit 59 is placed in the robotic vehicle as well. The vehicle is maneuvered to the desired location, such as below an IED 140 in a trunk of a vehicle 142. The shaped charge is elevated to its desired operating location, and is detonated. The detonation destroying the IED with a shaped water jet that cuts through the trunk and disseminates the IED, and in embodiments, designated critical portions of the robotic vehicle, such as remote control circuitry.

In particular embodiments, the shaped charge need not be placed to actively destroy critical portions of the robotic vehicle.

Referring to FIG. 33, in embodiments of the invention, a pair of drive mechanisms 150, each including at least a motor and a wheel are attached to each end of a shaped charge 154, the drive mechanisms having conforming shape to attach to the shaped charge such as by brackets 155 or other mechanical connectors. The drive mechanisms may have elevating capability. The shaped charge may have water jet and water blast capability on detonation.

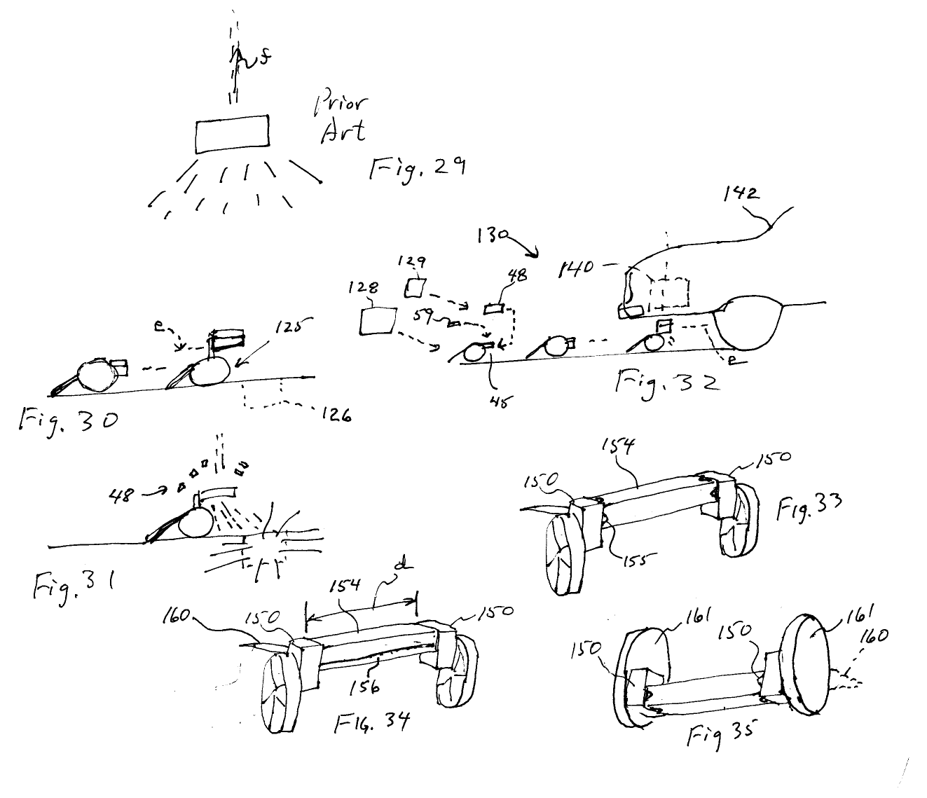

Referring to FIG. 34, in embodiments of the invention a pair of drive mechanisms 150 including a motor, gears and a wheel, are separated a distance d to receive a standardized size of a shaped charge, namely about 12.75 inches. Distance d may be 12.75 inches to 14 inches, for example. A spanning member configured as a chassis 156 may extend between the drive mechanisms setting said distance. The chassis and the two drive mechanisms define a shaped charge receiving region with a shaped charge 154 therein. The drive mechanisms may include height adjustment mechanisms. The chassis and shaped charge defining a body portion wherein most of the volume of the body portion between the two drive mechanisms is the shaped charge. The shaped charge may have water jet and water blast capability on detonation.

Referring to FIG. 34, in an embodiment, each of a pair of drive mechanisms are positioned at the end of a shaped charge, the shaped charge having water jet and water blast capability on detonation. Each drive mechanism may have height adjustment capability to raise and lower the shaped charge. At least one of the drive mechanisms may have an extending portion 160 therefrom for providing rotational stability about an axis extending through two wheels of the two drive mechanisms. The extending portion may be a tail to drag on the ground or a wheel that engages the ground.

Referring to FIG. 35, in an embodiment, each of a pair of drive mechanisms are positioned at the end of a shaped charge, the shaped charge having water jet and water blast capability on detonation. A body portion may extend between the wheels 161 and be positioned primarily at the lower halves of the wheels. The body portion may be, weight wise, mostly the shaped charge. The stability of the robotic vehicle, with respect to the driving capability, the wheels rotating rather than the body portion, may be from the weight of the shaped charge. An extending portion, such as a tail, may be optional for further stability. In an embodiment a robotic vehicle with a shaped charge comprises a body portion, a pair of drive mechanisms on each end of the body portion, and control circuitry, the body portion extending between the pair of drive mechanisms comprised at least substantially of the shaped charge.

Referring again to FIG. 16, a payload may include a device 170 mounted to the chassis in the payload receiving region that has an emission 172 that has a direction 174 of emission. The direction of emission may be controlled by tilting of the chassis. The emitting device may be an illumination device, a laser, a gas or fluid emission device, or a device that emits solid projectiles. The direction 174 of emission may be controlled by the tilting of the chassis. The chassis may be tilted about the y axis by raising or lowering one side of the chassis with respect to one set of wheels. For example, the left side pair of wheels 180 may be scissored together by moving the arms 92 together thus raising the left side of the chassis. The chassis may be rotated with respect to the z axis by rotating the chassis with respect to the two side assemblies on the left and right sides as indicated by the arrow 183. The chassis may be rotated about the x axis by operating the wheels to rotate the entire vehicle, generally the left side wheels in one direction, the right side wheels 186 in the opposite direction.

While the invention is amenable to various modifications and alternative forms, specifics thereof have been shown by way of example in the drawings and described in detail. It is understood, however, that the intention is not to limit the invention to the particular embodiments described. On the contrary, the intention is to cover all modifications, equivalents, and alternatives falling within the spirit and scope of the invention as defined by the appended claims.

1. A robotic vehicle for delivering a payload, comprising:
two side assemblies positioned on each of two sides of a chassis, each side assembly comprising:
a motor having an axle, and
a deployable tail, rotatable between a retracted position in which the tail is folded against the payload attachment section and a deployed position in which the tail extends outwardly from the payload attachment section to stabilize the vehicle; and
two removable wheels each positionable upon one of the axles
the robotic vehicle further including a camera and control circuitry for remote control.

2. The robotic vehicle of claim 1, wherein each side assembly further comprise a worm gear and a payload mount operably mounted to the payload attachment section, wherein the payload mount defines a threaded portion for engaging the worm gear such that the rotation of the worm gear moves the payload mount along the worm gear to elevate or lower the payload attachment section.

3. The robotic vehicle of claim 1, wherein the side assemblies suspend the payload attachment section at least about 6 inches above the ground when the removable wheels are attached.

4. A robotic vehicle comprising a chassis positioned between a pair of drive assemblies, each drive assembly having one of a wheel and two wheels, each wheel rotatable and movable in at least a vertical direction with respect to the chassis whereby when the wheels are on the ground, the chassis may be elevated and lowered, the chassis having at least one payload receiving region and the robotic vehicle further comprising a camera and control circuitry for remotely controlling driving of at least one wheel, the elevating and lowering of the chassis, and operation of the camera.

5. The robotic vehicle of claim 4 wherein the chassis is tiltable about two axis with respect to the wheels.

6. The robotic vehicle of claim 5 further comprising a laser attached to the chassis whereby the laser may provide point to or provide illumination of an object viewed by the camera

7. The robotic vehicle of claim 4 wherein the chassis is rotatable at least 180 degrees with respect to the wheels.

8. The robotic vehicle of claim 4 in combination with a payload, the payload comprising at least one of the set of: a shaped charge, an illumination device, a fluid dispensing device, and a laser.

9. The robotic vehicle of claim 4 wherein the robotic vehicle has a pair of wheels on each side, the wheels positioned at the ends of arms extending from the respective side assemblies, the chassis raisable by the arms being pivoted inwardly toward one another.

10. A robotic vehicle for delivering a payload, comprising:
a chassis,
only two ground engaging wheels, the wheels driven and positioned on each side of the chassis;
a shaped charge having a water jet capability upon detonation positioned in the chassis, the shaped charge substantially positioned between the two ground engaging wheels,
a camera and control electronics for remote control of the robotic vehicle.

11. The robotic vehicle of claim 10 further comprising an elevating mechanism attached to each side of the chassis for elevating the shaped charge.

12. The robotic vehicle of claim 10, wherein the chassis has thereon a wireless receiver for remote detonation of the shaped charge.

13. The robotic vehicle of claim 10 wherein the shaped charge has a water jet emitting direction and the control electronics are positioned in obstructing location to the water jet emitting direction.

14. A method of activating an IED comprising:
positioning a shaped charge having a water jet capability pointing upward and a water blast capability pointing downward in a robotic vehicle below designated critical control portions of the robotic vehicle to be destroyed;
remotely controlling the robotic vehicle to a detonation location adjacent an IED,
detonating the shaped charge thereby destroying the designated critical control portions of the robotic vehicle with the water jet and activating the IED with the water blast.

15. The method of claim 14 further comprising elevating the shaped charge when the robotic vehicle is at the detonation location.

16. A method of disabling or destroying IEDs comprising:
transporting a robotic vehicle that is at least one of collapsed and disassembled in a package to a location of use;
transporting a shaped charge in a separate package;
assembling the robotic vehicle;
placing the shaped charge in the robotic vehicle;
remotely controlling the robotic vehicle to a detonation location;
robotically raising the shaped charge to a desired location;
detonating the shaped charge.

17. The method of claim 16, further comprising selecting a shaped charge loaded with water for providing a water jet upon detonation.

18. The method of claim 16, further comprising selecting a shaped charge loaded with water to provide an upward water jet and a downward water blast on detonation.

19. The method of claim 16 further comprising destroying a designated critical portion of the robotic vehicle by positioning said designated critical portion in obstructing position with the water jet.

20. A method of disabling or destroying IEDs comprising:
placing a shaped charge capable of providing a water jet upon detonation in a robotic vehicle, the robotic vehicle having a designated critical portion including control circuitry, at least one of positioning the designated critical portion and orienting the shaped charge to direct the water jet at the designated critical portion;
remotely driving the robotic vehicle to a detonation location adjacent an IED candidate detonating the shaped charge.

21. The method of claim 20 further comprising raising the shaped charge by remote control.

22. A robotic vehicle with a chassis having a receiving region for accepting a shaped charge, a pair of driven wheels, one on each side of the receiving region and separated by at least the length of the shaped charge, the wheels rotatable by remote control and the chassis elevatable by remote control with respect to the wheels.

23. The robotic vehicle of claim 22 wherein the vehicle has only two driven ground engaging wheels and has a tail for stability.

24. The robotic vehicle of claim 22 further comprising a shaped charge in the receiving region, the shaped charge having a water jet capability.

25. The robotic vehicle of claim 22 wherein the vehicle has an additional two driven wheels one on each side of the receiving region.

26. A robotic vehicle with a chassis having a receiving region for accepting a payload that can be directed in a particular direction, the robotic vehicle comprising:
a pair of side assemblies mounted on each of two sides of the chassis, the side assemblies including a plurality of driven wheels, the chassis tiltable in at least two axis with respect to the wheels, the vehicle having a camera and a payload that has an emission, the payload attached to the chassis at the receiving region whereby the direction of the emission of the payload can be controlled by the remote tilting of the chassis.

27. The robotic vehicle of claim 26 wherein the payload comprises a laser.

28. The robotic vehicle of claim 26 wherein the payload comprises a shaped charge.

29. The robotic vehicle of claim 28 wherein the camera is pointing downwardly.
